(19) United States
(12) Patent Application Publication
(10) Pub. No.: US 2012/0207537 A1
(43) Pub. Date: Aug. 16, 2012

(54) METAL-PLASTIC COUPLING INTERFACE STRUCTURE AND MANUFACTURING METHOD THEREOF

(76) Inventor: MAO-LIEN HUANG, New Taipei City (TW)

(21) Appl. No.: 13/452,861

(22) Filed: Apr. 21, 2012

Related U.S. Application Data
(63) Continuation-in-part of application No. 12/538,166, filed on Aug. 10, 2009.

(51) Int. Cl. F16B 11/00; B23P 11/00; F16B 17/00

(52) U.S. Cl. 403/265; 403/375; 29/428; 264/138; 29/525.01; 29/525.12

(57) ABSTRACT

The present invention discloses a metal-to-nonmetal coupling structure that utilizes substantially symmetrically arranged coupling grooves in a metal substrate in conjunction with plastic molding technique to achieve secure structural coupling of components of different materials. A manufacturing method for the metal-nonmetal coupling interface structure is also disclosed to provide a simplified metal shell manufacturing process capable of achieving secure joining of various non-metal components onto a metal surface.

### BACKGROUND OF THE INVENTION

1. Field of the Invention

The present invention relates to a metal-to-plastic coupling interface structure and a manufacturing method thereof, and more particularly to a metal-to-nonmetal coupling structure that utilizes substantially symmetrically arranged coupling grooves in a metal substrate in conjunction with plastic molding technique to achieve secure structural coupling of components of different materials, and a manufacturing method thereof.

2. Description of Related Art

With the development of science and technology, various electronic products and electronic equipments occur. Metal constructed components are widely applied in these electronic products and electronic equipments, including external shell assembly and internal mechanism arrangement. Especially, internal mechanisms always have many functional components mounted therein, and the functional components need to be securely disposed in metal shells by metal manufacturing. Taking notebook computers for example, hardware, such as motherboards, hard disks, power supplies and so on, are mounted and fixed in metal shells.

As shown in FIG. 1A and FIG. 1B, a conventional manufacturing method includes: cutting a low positioning hole 2a in a surface of a metal substrate 1a, positioning an assembling pole 3a according with the size of the positioning hole 2a in the positioning hole 2a, and fixedly welding the assembling pole 3a in the positioning hole 2a by welding. At this time, a welding block 5a is connected with a bottom of the assembling pole 3a and an outer edge of the positioning hole 2a. A functional component 7a desired to be mounted is assembled in an assembling hole 4a (as shown in FIG. 2A and FIG. 2B) formed in the assembling pole 3a by a screw 6a, thereby completing the assembly.

However, the above-mentioned manufacturing method is very complicated: the size of the positioning hole 2a must be very accurately defined, and each positioning hole 2a needs to be cut separately and each assembling pole 3a needs to be positioned and welded separately. The same steps must be repeated on each position. So the more the components desired to be mounted are, the more the repeated steps are, which causes that the operation time is prolonged, the probability of failure is high, and the costs are quite high.

### SUMMARY OF THE INVENTION

One aspect of the present invention is to provide a metal-to-nonmetal coupling interface structure that utilizes substantially symmetrically arranged coupling grooves in a metal substrate in conjunction with plastic molding technique to achieve secure structural coupling of components of different materials. Another aspect of the instant disclosure provides a manufacturing method of the metal-to-nonmetal coupling interface structure having a simplified metal shell manufacturing process and capable of achieving secure joining of various non-metal components onto metal surfaces in a simple process, thereby reducing the costs and saving time.

To achieve the above-mentioned object, a metal-nonmetal coupling interface structure in accordance with the present invention is provided. The metal-nonmetal coupling interface structure comprises: a metal substrate having a top surface; at least one fixing groove structure having a central axis disposed on the top surface of metal substrate, where the lateral cross-section of the fixing groove structure comprises a pair of opposingly arranged slanting grooves substantially symmetrical to each other about the central axis of the fixing groove structure, where the slanting groove and the top surface of the metal substrate form an oblique angle; at least one plastic layer disposed on the metal substrate and fastened in the fixing groove structure; and at least one assembling hole exposedly formed in the plastic layer and accessible from a top surface thereof.

To achieve the above-mentioned object, a metal shell manufacturing method executed by a metal shell manufacturing cutter device for producing the same in accordance with the present invention is provided. The metal shell manufacturing method executed by the cutter includes the steps of:

(1). providing a metal substrate;

(2) providing a metal shell manufacturing cutter device with a knife module in a hollow cylindrical shape, having a main body, at least two blade bodies, at least two extension ends, at least two blade heads at least two spaces formed between the blade bodies in lateral direction, wherein the knife module is rotatable upon an axis, and the blade heads stretches out from the blade bodies in an angle, the blade heads together form at least one pair of partial cyclic hook structure opposite to each other, the partial cyclic hook structure forms a variable diameter, which is further controlled by a pressing tool contacted to the extension ends,;

(3). Abutting the knife module against the metal substrate with slightly pressing on the metal substrate so that the blade heads of the partial cyclic hook structure make a primary cut in an oblique angle and form at least one shallow groove in the metal substrate;

(4) subsequently pressing the pressing tool to further compress the extension ands so that the blade heads keep moving laterally in substance more and the diameter of partial cyclic hook structure alters to make a secondary cut to form at least one fixing groove in the metal substrate, the secondary cut resulting in a wider fixing groove groove;

(5) the fixing groove further extending into the metal substrate in a deeper oblique angle from the shallow groove while the diameter of the partial circle hook structure alters;

(6) relaxing the pressing tool to decrease the pressing of the extension end so that the blade head deviated from the fixing groove laterally in substance, completing the fixing groove; and

(7) disposing at least one plastic layer on the metal substrate, the plastic layer fastened in the fixing groove and fixed on the metal substrate; and forming at least one assembling hole in the plastic layer, the assembling hole extending into the plastic layer from a surface of the plastic layer.

In the metal-nonmetal coupling interface structure and method of the present invention, the formed plastic layers are fastened in the fixing groove structure directly and the plastic layers and the assembling holes can be formed in one piece via a mold, so there is no need for cutting a hole separately and welding the assembling poles like prior arts, thereby simplifying the manufacturing process, reducing the costs, saving time and maximizing the efficiency for manufacturing metal shells.

### BRIEF DESCRIPTION OF THE DRAWINGS

FIG. 1A is a first top view of a prior art;

FIG. 1B is a first cross-sectional view of the prior art;

FIG. 2A is a second top view of the prior art;

FIG. 2B is a second cross-sectional view of the prior art;

FIG. 3A is a cross-sectional side view of a knife module assembled in a metal shell manufacturing cutter device of the present invention;

FIG. 3B is in a cross-sectional bird's eye view of the knife module;

FIG. 3C is a cross-sectional side view of the knife module;

FIG. 4 is a cross-sectional side view of the knife module when executing a primary cut on a metal substrate;

FIG. 5A is a cross-sectional side view of a metal substrate with a shallow groove produced by a primary cut;

FIG. 5B is a cross-sectional side view of a metal substrate with a fixing groove produced by a secondary cut;

FIG. 5C is a bird's eye view of a metal substrate with a fixing groove produced in a cutting way;

FIG. 5D is a bird's eye view of a metal substrate with a fixing groove produced in a pressing way;

FIG. 6A is a knife module with a lock protruding from the coat into the blade body in a cross-sectional bird's eye view;

FIG. 6B is a cross-sectional side view of the knife module according to FIG. 6A;

FIG. 7A is an outwards-stretching blade of the knife module with a lock protruding from the blade body into the coat in a cross-sectional bird's eye view;

FIG. 7B is an outwards-stretching blade of the knife module with a lock protruding from the blade body into the coat in a cross-sectional side view according to FIG. 7A;

FIG. 8A is an outwards-stretching blade of the knife module with a lock protruding from the coat into the blade body in a cross-sectional bird's eye view;

FIG. 8B is an outwards-stretching blade of the knife module with a lock protruding from the coat into the blade body in a cross-sectional side view according to FIG. 8A;

FIG. 9A is an cross-sectional side view of a metal substrate with a shallow groove produced by an primary cut of outwards-stretching blade of the knife module;

FIG. 9B is an cross-sectional side view of a metal substrate with a fixing groove produced by an secondary cut of outwards-stretching blade heads of the knife module;

FIG. 10A is a first top view of a metal-nonmetal coupling interface structure of the present invention;

FIG. 10B is a partially enlarged top view of part A in FIG. 10A;

FIG. 10C is a partially enlarged cross-sectional side view of part A in FIG. 10A;

FIG. 11A is a second top view of the metal-nonmetal coupling interface structure of the present invention;

FIG. 11B is a partially enlarged top view of part B in FIG. 11A;

FIG. 11C is a partially enlarged cross-sectional side view of part B in FIG. 11A;

FIG. 12A is a third top view of the metal-nonmetal coupling interface structure of the present invention;

FIG. 12B is a partially enlarged top view of part C in FIG. 12A;

FIG. 12C is a partially enlarged cross-sectional side view of part C in FIG. 12A;

FIG. 13A is a fourth top view of the metal-nonmetal coupling interface structure of the present invention;

FIG. 13B is a partially enlarged top view of part D in FIG. 13A;

FIG. 13C is a partially enlarged cross-sectional side view of part D in FIG. 13A; and

FIG. 14 is a flow chart of a metal shell manufacturing method of the present invention.

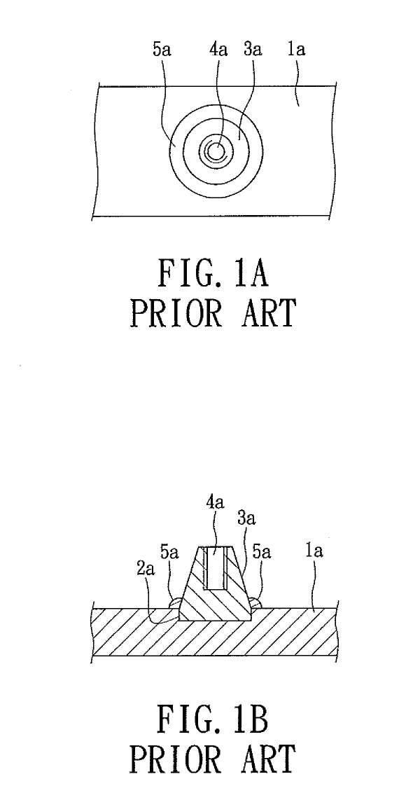

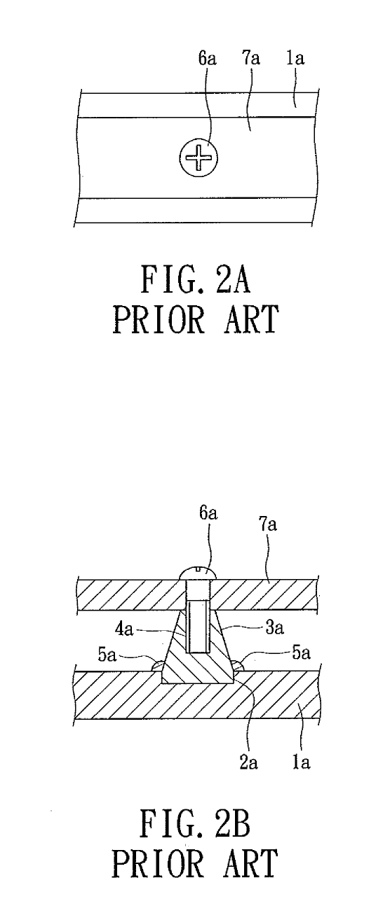

### DETAILED DESCRIPTION OF THE PREFERRED EMBODIMENTS

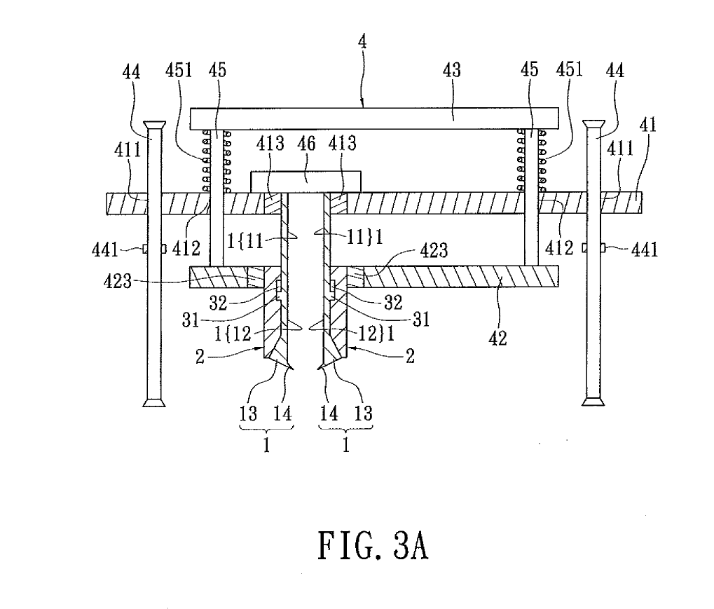

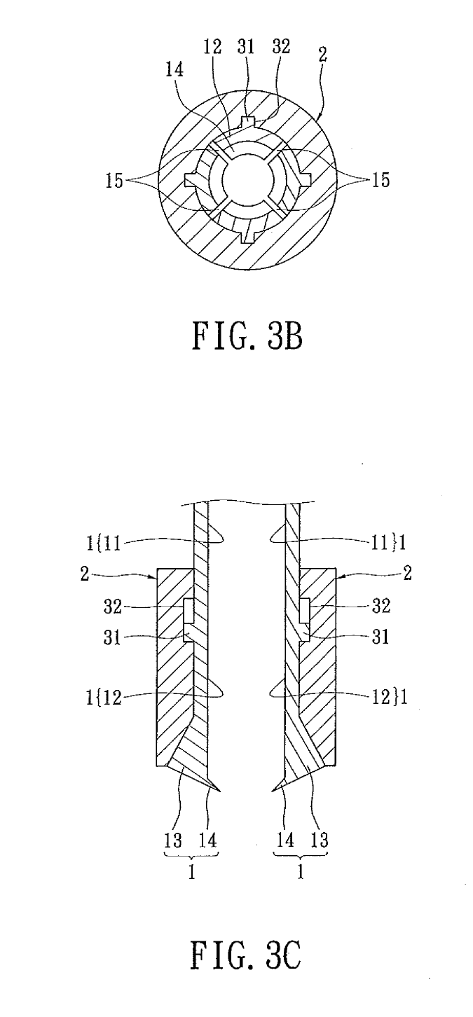

Please refer to FIG. 3A-3C, illustrating a metal shell manufacturing cutter device suitable for manufacturing the metal-to-plastic coupling interface structure in accordance with the instant disclosure. The present invention utilizes a metal shell manufacturing cutter which includes a knife module I and a pressing tool 2. The knife module 1 is in a hollow cylindrical shape, having a main body 11, at least two blade bodies 12, at least two extension ends 13 at least two blade heads 14, at least two spaces 15 formed between the blade bodies 12. In this embodiment, as shown in FIG. 3B and 3C, the knife module 1 concludes a main body 11, four blade bodies 12, four extension ends 13, four blade heads 14 and four spaces 15 formed between the blade bodies 12. The four spaces 15 between each blade bodies 12 result in capable of elastic and substantially-lateral moving of the four blade bodies 12 as well as the blade heads 14. The four extension ends 13, in this embodiment, extend downward and outward from the blade bodies 12 to form a surrounding angle. From a cross-sectional bird's eye view and a cross-sectional view, the blade heads 14 represent an inner partial cyclic hook structure. In addition, the inner partial cyclic hook structure of the blade heads 14 can move in an elastically and substantially lateral way. The four blade heads 14 extend from bottom end of each blade bodies 12 and the blade heads 14 together with the blade bodies 2 constitute an inwards angle. The knife module 1 is capped with the pressing tool 2 and the bottom end of the pressing tool 2 contacts against the extension ends 13.

All elements of the knife module 1 are integrally joined. In particular, the blade bodies 12 are further connected to the pressing tool 2 by protruding a lock 31 from the blade body 12 into the pressing tool 2, and on the lock 31 is a lifting space 32. The at least two blades 14 are now four blades 14 in this preferred embodiment. The four spaces 15 between each blade bodies 12 as well as the blade heads 14, make it allowable, when pressing the pressing tool 2 to the extension ends 13, a substantially lateral and elastic movement of the blade bodies 12 as well as the blade heads 14.

The knife module 1 is set on a machining equipment 4 which includes a first table 41, second table 42, third table 43, at least two first sliding posts 44, at least two second sliding posts 45 and a driving device 46. The first table 41 is located between the second table 42 and the third table 43, the three tables are parallel to each other. The first table 41 has at least two first holes 411 penetrating thereon, mounted with at least two first sliding posts 44, so that the first table 41 is able to move up and down along the first sliding post 44. Each of the sliding posts 44 has a position limit 441 for limiting the lowest position of the first table 41, which is referred as primary cutting site, to carry out primary cut. The second sliding post 45 is set through the second sliding hole 412 penetrating on the first table 41 and the second sliding post 45 is fixed to the second table 42 and third table 43 so that the second and third table 42, 43 move up and down together relative to the first table. Each second sliding post 45 possesses a spring thereon between the first table 41 and the third table 43(in this embodiment) or the first table 41 and the second table 42, providing an elastic force of buffer and a restoring position.

A knife-module bearing 413 capable of rotating is set on the first table 41 so that the knife module 1 is able to rotate upon its axis as the driving device 46 acts. The second table 42 has a pressing-tool bearing 423 penetrating thereon under the knife-module bearing 413 and the upper end of the pressing tool 2 is connected to the pressing-tool bearing 423, contributing the rotating of the pressing tool 2 upon the axis.

The driving device 46 is responsible for the simultaneous rotating of the knife-module bearing 413 and the pressing-tool bearing 423 as well as the simultaneous rotating of the knife module 1 and the pressing tool 2. In another way, the driving device 46 can be responsible for the independent rotating of the knife-module bearing 413 only, or can be responsible for the independent rotating of the pressing-tool bearing 423 only and then subsequent can be responsible for linking-up of the simultaneous rotating of the knife module 1 combined with the pressing tool 2 by means of the lock 31 and the lifting space 32. The driving device 46 is also responsible for the rise and drop of the first 41, second 42 and third 43 tables.

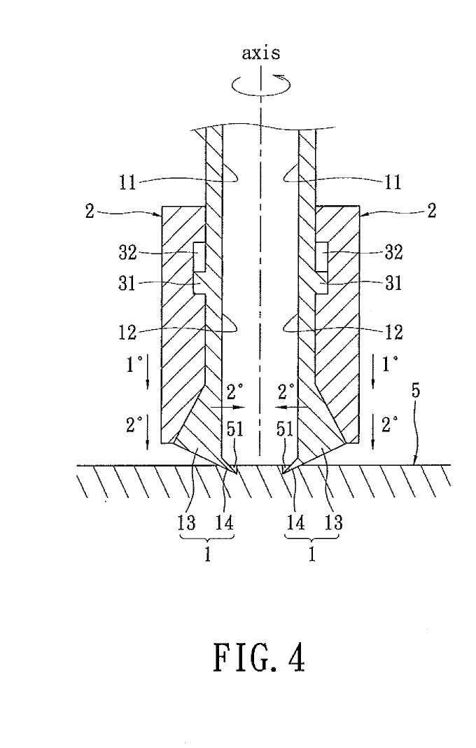

The knife module 1 is connected to a driving device 46 on top, providing power to drive the pressing tool 2. The pressing tool 2 is connected to a first table 41 and a second table 42 with an outer knife-module bearing 413 and an outer pressing-tool bearing 423 respectively so that the pressing tool 2 is able to rotate upon the axis (FIG. 4) and further to drive the whole knife module 1, the blade heads 14, as well as the main bodies 11, to rotate. While rotating, the second table 42 is able to rise and drop independently to the first table 41, and the rise or drop of the second table 42 is controlled by the third table 43.

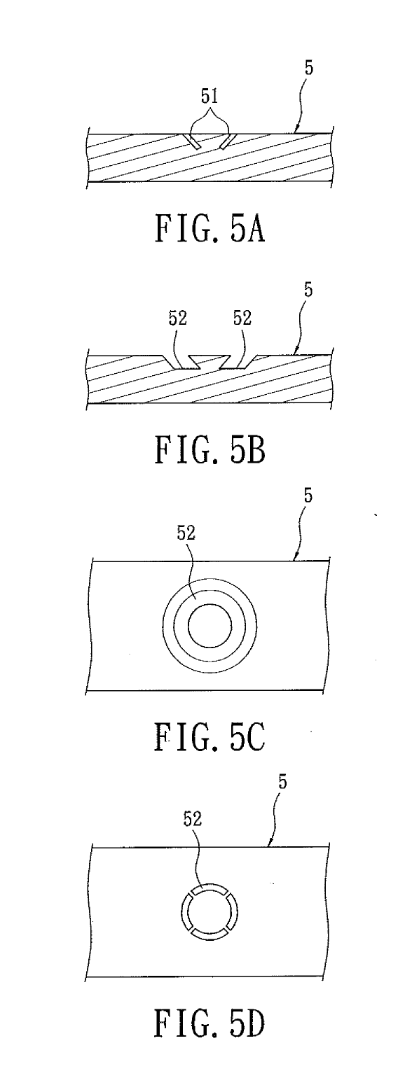

Please refer to FIG. 3A, 4, 5A-5D. By pressing down the first table 41, the knife module 1 is abutted against the metal substrate slightly to make a primary cut and form at least one shallow groove in the metal substrate as well as causing an oblique angle in the metal substrate 5. By pressing down the second 42 or the third 43 table continuingly, the pressing tool 2 is pressed to subsequently compress the extension ends 13 so that the blade heads 14 are compressed to move laterally in substance, causing a variable diameter of the partial cyclic hook structure, and to make a secondary cut. In this embodiment, however, the variable diameter means a reduced diameter, causing an inner cut to complete the primary and secondary cut. And the secondary cut is of non-fullness cut. Thereafter at least one fixing groove 52 is formed. Furthermore, the knife module 1 is allowed to rotate for treating the metal substrate 5 in a cutting method or to be kept steady for treating the metal substrate 5 in a pressing mehtod when exposing to the metal substrate 5. If the cutting method is used, a fixing groove structure 52 of continuous enclosed circle (viewed from a bird's eye) can be formed (FIG. 5C). If the pressing method is used, a discontinuous circle, or a half-moon shaped fixing groove structure 52 (viewing from an overhead view) may be formed (FIG. 5D). When the fixing groove 52 is completed, the blade heads 14 can be departed form the fixing groove 52 laterally in substance by decreasing the pressing of the second 42 or the third 43 table and then the first table 41 for preventing the blade heads 14 from destroying the fixing groove 52.

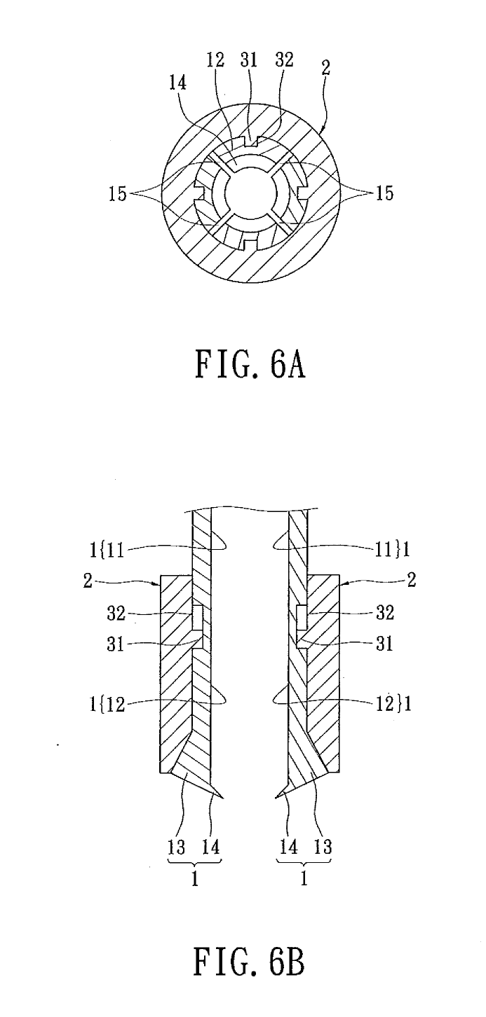

Please refer to FIG. 6A and 6B, illustrating another embodiment of lock 31 which is protruded from the pressing tool 2 into the blade bodies 12.

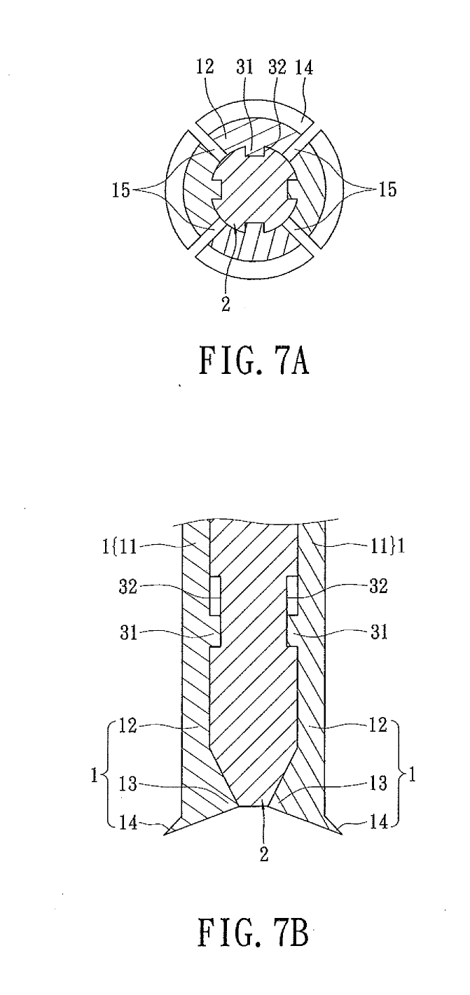

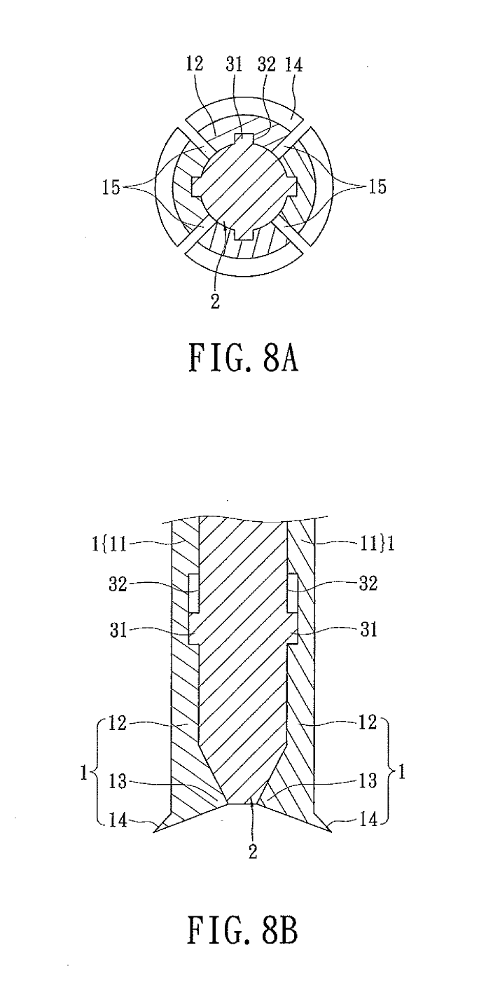

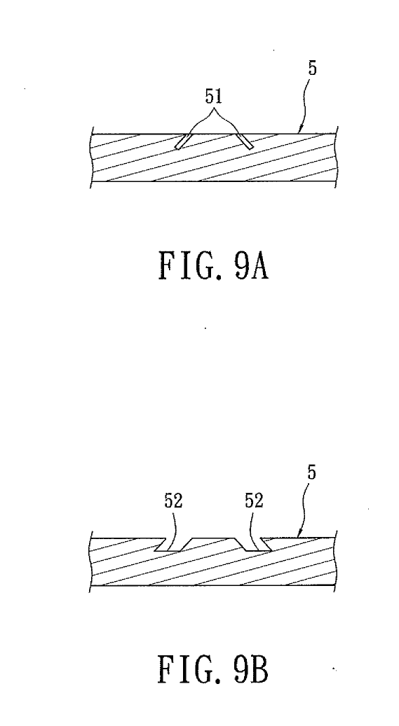

Please refer to FIG. 7A-7B and FIG. 9A-9B illustrating another embodiment of the knife module 1 and the fixing groove 52 caused by the knife module 1. The blade heads 14 are turned outwards in an angle to the blade bodies 12 to form an outer partial cyclic hook structure with the spaces 5 between the blade bodies 12, and the pressing tool 2 is set inside the knife module 1. The extension ends 13 protrude inwards from the back of the blade heads 14 and contact to the pressing tool 2, therefore, when pressing the pressing tool 2, the compression to the extension ends 13 initiated by the pressing tool 2 causes the blade heads 14 to move laterally in substance. In this embodiment, the blade heads 14 form an outer partial cyclic hook structure with the spaces 15 between the blade bodies 12. At the mean time, the spaces 15, of course, provides space for the lateral moving of the blade heads 14r as blade heads 14 keep moving outwards in a bigger lateral range. Similar to the FIG. 5C and 5D, the blade heads 14 can also be used in a cutting way or a pressing way to produce a continuous-enclosed circle of fixing groove 52 or a discontinuous circle of fixing groove 52 from a bird's eye. And it's also in a similar way, shown as FIG. 7A-7B and FIG. 8A-8B, the lock 31 can be protruded from the blade bodies 12 or from the pressing tool 2 respectively.

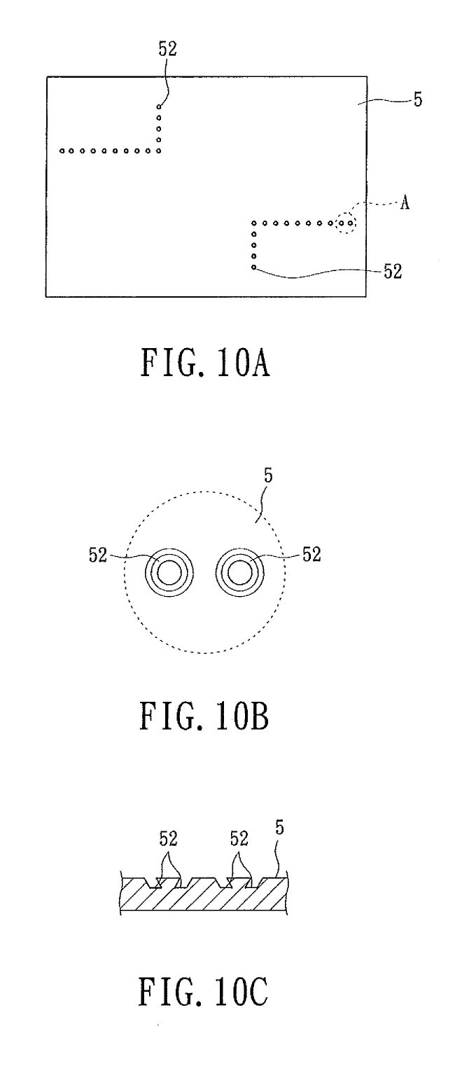

Please refer to FIGS. 10A-10C, FIGS. 11A-11C, FIGS. 12A-12C and FIGS. 13A-13C, illustrating a metal-nonmetal coupling interface structure according to the present invention. The metal-nonmetal coupling interface structure includes a metal substrate 5 having a top surface; at least one fixing groove structure 52 having a central axis disposed on the top surface of metal substrate, where the lateral cross-section of the fixing groove structure comprises a pair of opposingly arranged slanting grooves substantially symmetrical to each other about the central axis of the fixing groove structure, and where the slanting groove and the top surface of the metal substrate form an oblique angle; at least one plastic layer 6 molded into the slanting groove Of the fixing groove structure, thereby retained atop the top surface of the metal substrate 5; and at least one assembling hole 7 exposedly formed in the plastic layer and accessible from a top surface thereof. The fixing groove structure 52 is formed in the metal substrate 5, the plastic layer 6 is disposed on the metal substrate 5 and fastened in the fixing groove structure 52, and the assembling hole 7 is formed in the plastic layers 6.

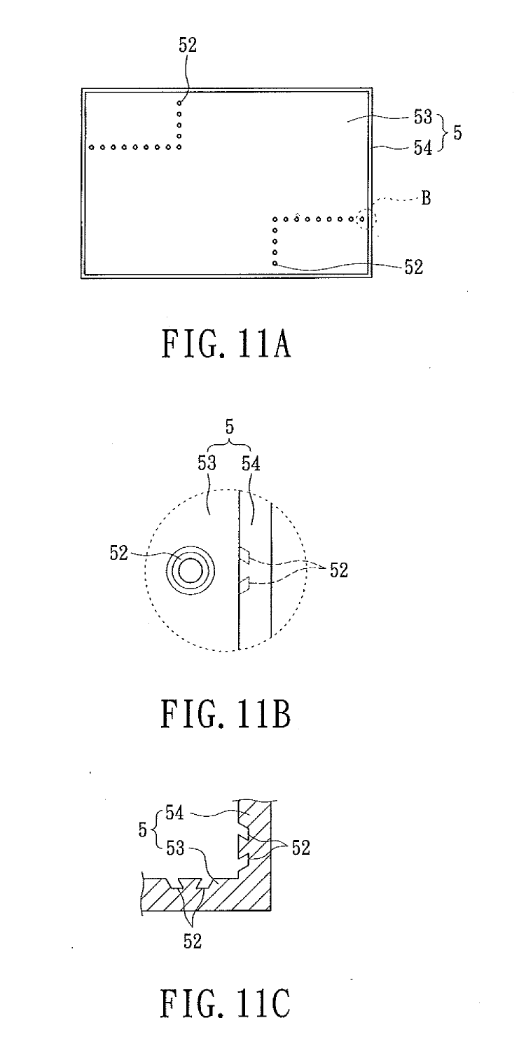

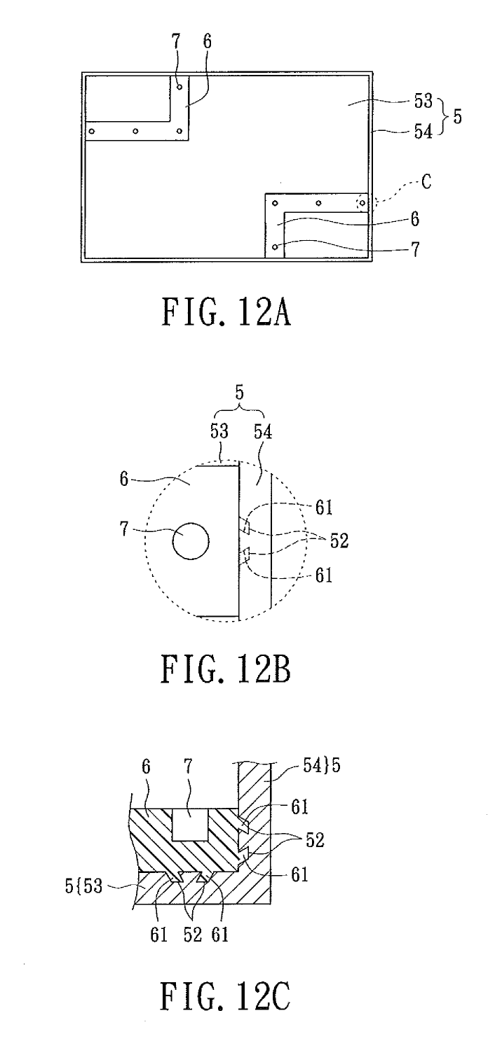

As shown in FIGS. 10A-10C, the metal substrate 5 originally has a smooth top surface. The fixing groove structure 52 are formed at a desirable location on the the metal substrate 5, by a drilling machine, a lathing machine, a punching machine, a milling machine or other machining equipments. The fixing groove structure 52 extends slantingly into the metal substrate 5 from the top surface of the metal substrate 5 at an oblique angle. Specifically, in the cross-sectional view, the fixing groove structure 52 and the surface of the metal substrate 5 form an oblique angle therebetween so that the plastic layers 6 can be molded into and fastened in the fixing groove structure 52. As shown in FIGS. 11A-11C, according to desired appearances of products, the metal substrate 1 may include a bottom board 53 and at least one side board 54 which are formed by punching. The side board 54 is located on the periphery of the bottom board 53 and the bottom board 53 is perpendicular to the side board 54. The bottom board 53 and the side board 54 both have the fixing groove structure 52. Further, as shown in FIGS. 12A-12C, in a mold-forming way, the plastic layers 6 are formed on the metal substrate 5 and the assembling holes 7 are formed in the plastic layers 6 and extend into the plastic layer 6 from a surface of the plastic layer 6. The plastic layers 6 and the assembling holes 7 may have an integrated structure formed by mold-forming,

The desired mold has a shape and structure according with the manufacturing demands. By injection molding or other forming ways, the molten plastic material is coated on the metal substrate 5 and filled in the fixing groove structure 52. After the plastic material is solidified, the mold is removed and the plastic layers 6 are formed on the metal substrate 5. Based on the plastic material filled in the fixing groove structure 52, each formed plastic layer 6 has at least one fastening portion 61, and the plastic layer 6 may be fastened in the fixing groove structure 52 of the bottom board 53 or the fixing groove structure 52 of the side board 54 via the fastening portion 61 and fixed on the metal substrate 5. Because the plastic layers 6 and all the assembling holes 7 may be formed in one piece directly via the mold, so there is no need for cutting a hole separately.

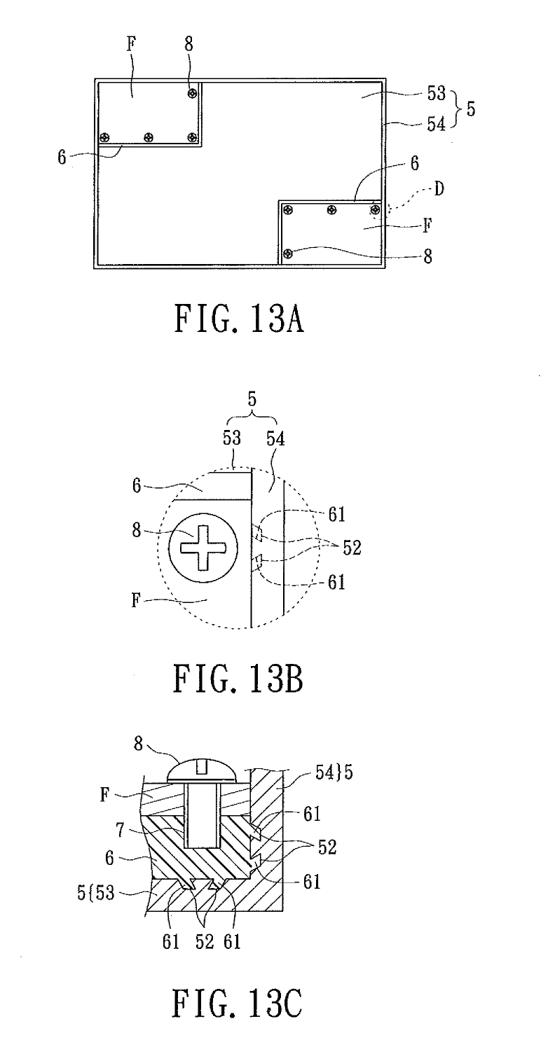

Any component may be disposed on the metal-nonmetal coupling interface structure easily, for example, motherboards, hard disks, power supplies, etc. As shown in FIGS. 13A-13C, at least one functional component F is assembled in the assembling holes 7 via at least one assembling device 8 so as to mount the functional component F on the metal-nonmetal coupling interface structure. The assembling holes 7 may be mold-formed to be screw holes, fastening holes or other kinds of assembling holes. The assembling devices 8 may be screws, tenons or other kinds of assembling devices.

In the metal-nonmetal coupling interface structure, the number, shapes and positions of the fixing groove structure 52, the plastic layers 6 and the assembling holes 7 may be defined according to the configuration and arrangement of the functional components F. The larger the number of fixing groove structure 52 is, the more stably the plastic layer 6 is fixed on the metal substrate 5. Based on shapes of cutting tools and manufacturing modes of manufacturing devices, besides the circular shape in the embodiment, the plane shape of the fixing groove structure may be other shapes, not limited herein. Additionally, the assembling holes 7 may also be formed by drilling, not limited in mold-forming.

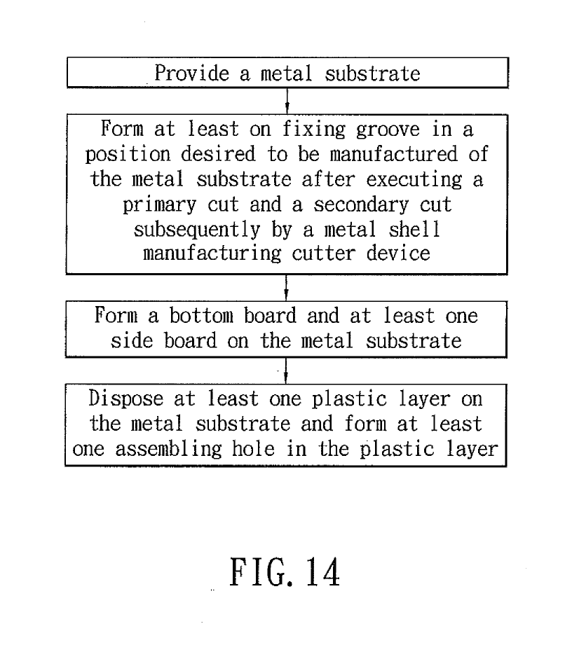

Accordingly, please refer to FIG. 14 simultaneously, the present invention provides a metal shell manufacturing method by using a metal manufacturing cutter device which includes the steps of:

(1). providing a metal substrate 5;

(2). as shown in FIGS. 4 and 5A-5D, FIG. 7B, FIG. 8B or FIG. 9A-9B, forming at least one fixing groove 52 in the position desired to be manufactured of the metal substrate 5 after executing a primary cut and a secondary cut subsequently by the metal shell manufacturing cutters device, wherein the fixing groove 52 extends into the metal substrate 5 from the surface of the metal substrate 5, and the fixing groove 52 and the surface of the metal substrate 5 form an oblique angle therebetween to enhance the fastening and fixing effect for the plastic layer molded thereon;

(3). as shown in FIGS. 11A-11C, punching the metal substrate 5 according to the desired shape of a product to form a bottom board 53 and at least one side board 54 on the metal substrate 5, wherein the side board 54 is located on the periphery of the bottom board 53 and the bottom board 53 is perpendicular to the side board 54, the bottom board 53 and the side board 54 both have the fixing groove structure 52;

(4). as shown in FIGS. 12A-12C, disposing at least one plastic layer 6 on the metal substrate 5 in a mold-forming way and forming at least one assembling hole 7 in the metal substrate 5, wherein the assembling hole 7 extends into the plastic layer 6 from the surface of the plastic layer 6, the plastic layer 6 and the assembling hole 7 have an integrated structure formed by mold-forming, the plastic layer 6 is fastened in the fixing groove 52 and fixed on the metal substrate 5, the plastic layer 6 and all the assembling holes 7 may be formed in one piece via a mold, without a hole being cut separately. The assembling hole 7 may be mold-formed to be screw holes, fastening holes or other kinds of assembling holes.

Furthermore, in the step (4), the assembling holes 7 may also be formed by drilling, not limited in mold-forming.

After the metal shell manufacturing method, as shown in FIGS. 13A-13C, at least one functional component F is assembled in the assembling holes 7 via at least one assembling device 8. The assembling devices 8 may be screws, tenons or other kinds of assembling devices.

Based on the above mentioned metal-nonmetal coupling interface structure and method of the present invention, the formed plastic layers 6 are fastened in the fixing groove structure. 52 directly and don't need to be fixed separately by welding, and the plastic layers 6 and all the assembling holes 7 may be formed in one piece via a mold, without a hole being cut separately. Accordingly, the manufacturing process is simplified, the costs are reduced, time is saved and the efficiency for manufacturing metal shells is maximized.

What are disclosed above are only the specification and the drawings of the preferred embodiments of the present invention and it is therefore not intended that the present invention be limited to the particular embodiments disclosed. It will be understood by those skilled in the art that various equivalent variations may be made depending on the specification and the drawings of the present invention without departing from the scope of the present invention.

What is claimed is:

1. A metal-nonmetal coupling interface structure, comprising:
a metal substrate having a top surface;
at least one fixing groove structure having a central axis disposed on the top surface of metal substrate, wherein the lateral cross-section of the fixing groove structure comprises a pair of opposingly arranged slanting grooves substantially symmetrical to each other about the central axis of the fixing groove structure, wherein the slanting groove and the top surface of the metal substrate form an oblique angle;
at least one plastic layer, disposed on the metal substrate and fastened in the fixing groove structure; and
at least one assembling hole, exposedly formed in the plastic layer and accessible from a top surface thereof.

2. The metal-nonmetal coupling interface structure as claimed in claim 1, wherein the plastic layer is disposed on the metal substrate by a molding method, wherein the plastic layer and the assembling hole are of an integrally molded one piece structure.

3. The metal-nonmetal coupling interface structure as claimed in claim 1, wherein the assembling hole is formed by drilling.

4. The metal-nonmetal coupling interface structure as claimed in claim 1, wherein the assembling hole is a screw hole or a fastening hole.

5. The metal-nonmetal coupling interface structure as claimed in claim 1, wherein the fixing groove is a discontinuous circle composed of half-moon shape or a continuous enclosed circle from a overhead view.

6. The metal-nonmetal coupling interface structure as claimed in claim 1, wherein the metal substrate includes a bottom board and at least one side board located on the periphery of the bottom board.

7. The metal-nonmetal coupling interface structure as claimed in claim 6, wherein the bottom board and the side board both have the fixing groove.

8. A metal-nonmetal coupling interface structure manufacturing method, comprising the steps of:
(1). providing a metal substrate;
(2) providing a metal shell manufacturing cutter device with a knife module in a hollow cylindrical shape, having a main body, at least two blade bodies, at least two extension ends, at least two blade heads, at least two spaces formed between the blade bodies in lateral direction, wherein the knife module rotatable upon an axis, and the blade heads stretch out from the blade bodies in an angle, the blade heads together form at least one pair of partial cyclic hook structure opposite to each other, the partial cyclic hook structure forms a variable diameter which is further controlled by a pressing tool contacted to the extension ends;
(3) abutting the knife module against the metal substrate with slightly pressing on the metal substrate so that the blade heads of the partial cyclic hook structure make a primary cut in an oblique angle and form at least one shallow groove in the metal substrate;
(4) subsequently pressing the pressing tool to further compress the extension ends so that the blade heads keep moving laterally in substance more and the diameter of partial cyclic hook structure alters to make a secondary cut to form at least one fixing groove in the metal substrate, the secondary cut resulting in a wider fixing groove structure;
(5) the fixing groove further extending into the metal substrate in a deeper oblique angle from the shallow groove while the diameter of the partial circle hook structure alters;
(6) relaxing the pressing tool before full cutting of the secondary cut to decrease the pressing of the extension end so that the blade head deviated from the fixing groove laterally in substance, completing the fixing groove; and
(7). disposing at least one plastic layer on the metal substrate, the plastic layer fastened in the fixing groove and fixed on the metal substrate; and
forming at least one assembling hole in the plastic layer, the assembling hole extending into the plastic layer from a surface of the plastic layer.

9. The metal shell manufacturing method as claimed in claim 8, wherein in the step (2), the blade heads stretch inwards to form an inner partial cyclic hook structure with the spaces between the blade bodies.

10. The metal shell manufacturing method as claimed in claim 8, wherein in the step (2), the blade head stretch outwards to form an outer partial cyclic hook structure with the spaces between the blade bodies.

11. The metal shell manufacturing method as claimed in claim 8, wherein in the step (3), while abutting the knife module against the metal substrate, the knife module is rotating.

12. The metal shell manufacturing method as claimed in claim 11, wherein in the step (3), the fixing groove forms a continuous enclosed-circle from a bird's eye view.

13. The metal shell manufacturing method as claimed in claim 8, wherein in the step (3), the fixing groove forms a discontinuous circle composed of half-moon shape from a bird's eye view.

14. The metal shell manufacturing method as claimed in claim 8, wherein in the step (7), the plastic layer is disposed on the metal substrate in a mold-forming way, and the plastic layer and the assembling hole have an integrated structure formed by mold-forming.

15. The metal shell manufacturing method as claimed in claim 8, wherein in the step (7), the assembling hole is formed by drilling.

16. The metal shell manufacturing method as claimed in claim 8, wherein the assembling hole is a screw hole or a fastening hole.

17. The metal shell manufacturing method as claimed in claim 8, wherein in the step (7), at least one functional component is assembled in the assembling hole via at least one assembling device.

18. The metal shell manufacturing method as claimed in claim 14, wherein the assembling device is a screw or a tenon.
